(19) United States
(12) Patent Application Publication
(10) Pub. No.: US 2007/0032100 A1
(43) Pub. Date: Feb. 8, 2007

(54) Replaceable input/output interface for circuit board

(75) Inventors: Shou-Wei Yang, Taoyuan (TW); Shang-Ti Kuo, Taoyuan (TW)

Correspondence Address: BIRCH STEWART KOLASCH & BIRCH, PO BOX 747, FALLS CHURCH, VA, 22040-0747, US

(73) Assignee: TYAN COMPUTER CORP

(21) Appl. No.: 11/253,687

(22) Filed: Oct. 20, 2005

(30) Foreign Application Priority Data
Aug. 3, 2005 (TW) 94126398

(51) Int. Cl. H01R 29/00

(52) U.S. Cl. 439/43

(57) ABSTRACT

A certain position of a circuit board is provided for configuring plural first and second electrical contacts therein to selectively connect a first signal connecting port or a second signal connecting port within the certain position. The first and second electrical contacts are in circuit connection with one or more signal processor to respectively transmit a first and a second signal for processing. A circuit switch is set in circuit connection between the first electrical contacts and the signal processor, which has a signal connecting element as an extra transmission interface of the first signal thereon.

This Non-provisional application claims priority under 35 U.S.C. § 119(a) on Patent Application No(s). 094126398 filed in Taiwan on Aug. 3, 2005, the entire contents of which are hereby incorporated by reference.

### BACKGROUND OF THE INVENTION

1. Field of Invention

The present invention relates to a structure sharing design of connecting ports, in particular, to a replaceable input/output connecting interface applied to circuit boards.

2. Related Art

Nowadays, in order to meet different design requirements of customers on different input/output (I/O) connecting interfaces, manufacturers of circuit boards (like motherboards) modify the circuit design depending on the circuit specification required by customers, to produce various new models which meet different specific requirements as possible. However, it not only increases the cost of development and manufacture, but also raises other problems, such as materials preparing, manufacture rescheduling and inventory managing for two models. Furthermore, even when the circuit specifications are changed not too much, the manufacturers still need to redesign the specification and circuits of the circuit board, causing a waste of time and labor.

FIG. 1 shows an integrated module for plural input/output connectors of a computer system in the prior art. The I/O connecting ports 721, 722, 723, and 724 are integrated on a circuit board 72 with implicated circuits (not shown) operatively connecting to an integrated terminal 725. The integrated terminal 725 is an interface applicable to electrically couple with a connecting terminal 712, which is attached to a flexible flat cable 71 with another connecting terminal 711 configured on a motherboard 70 of the portable computer. Then data transmission can be performing between the I/O connecting ports 721, 722, 723, 724, and the motherboard 70. Therefore, a portable computer can meet more requirements by simply changing circuit boards with various combinations of connecting ports.

Although modularization of the connecting ports makes the specification of motherboard much more flexible to design, how to fasten the circuit board module onto the motherboard becomes a new issue. Furthermore, for a specific position on a circuit board with certain layout, there is no other connector can be applied to the same position. In other words, such designs still lack flexibility for spatial arrangement. Engineers have to choose predetermined connector and give up another.

Therefore, how to provide a circuit design capable of flexibly replacing different connecting interfaces at the same position of the circuit board and a solution without abandoning any function to meet the requirement for products of different specification becomes one of the problems to be solved by researchers.

### SUMMARY OF THE INVENTION

In view of the above problems, the present invention provides a replaceable input/output interface for a circuit board. Through the special circuit architecture, the interface configured at a certain physical position of the circuit board may be replaceable as required and even the requirement for multi-functions is considered to facilitate the manufacture, thereby shortening the time of manufacturing the motherboard and reducing the cost of design and management.

Therefore, in one aspect of the present invention, a circuit board is provided for selectively configuring a first signal connecting port or a second signal connecting port at a certain position located on the circuit board. The circuit board comprises a peripheral signal processor, plural first electrical contacts, plural second electrical contacts, and a circuit switch. The peripheral signal processor is for processing a first signal and a second signal. The first electrical contacts are configured within the certain position for electrically connecting the first signal connecting port, and in circuit connection with the peripheral signal processor to transmit the first signal. The second electrical contacts are also configured within the certain position for electrically connecting the second signal connecting port, and in circuit connection with the peripheral signal processor to transmit the second signal. The circuit switch, used for circuit connection/disconnection, is configured in circuit connection between the first electrical contacts and the peripheral signal processor.

In one aspect of the present invention, the circuit switch has one or more signal connecting element as an extra transmission interface of the first signal.

In one aspect of the present invention, the circuit board further comprises a first signal processor for processing the first signal, which is configured in circuit connection between the peripheral signal processor and the circuit switch.

In one aspect of the present invention, the circuit board further comprises a second signal processor for processing the second signal, which is configured in circuit connection between the peripheral signal processor and the second electrical contacts.

Other aspects and advantages of the invention will be apparent from the following description combined with the accompanying drawings and the appended claims.

### BRIEF DESCRIPTION OF THE DRAWINGS

FIG. 1 shows an integrated module for plural input/output connectors of a computer system in the prior art;

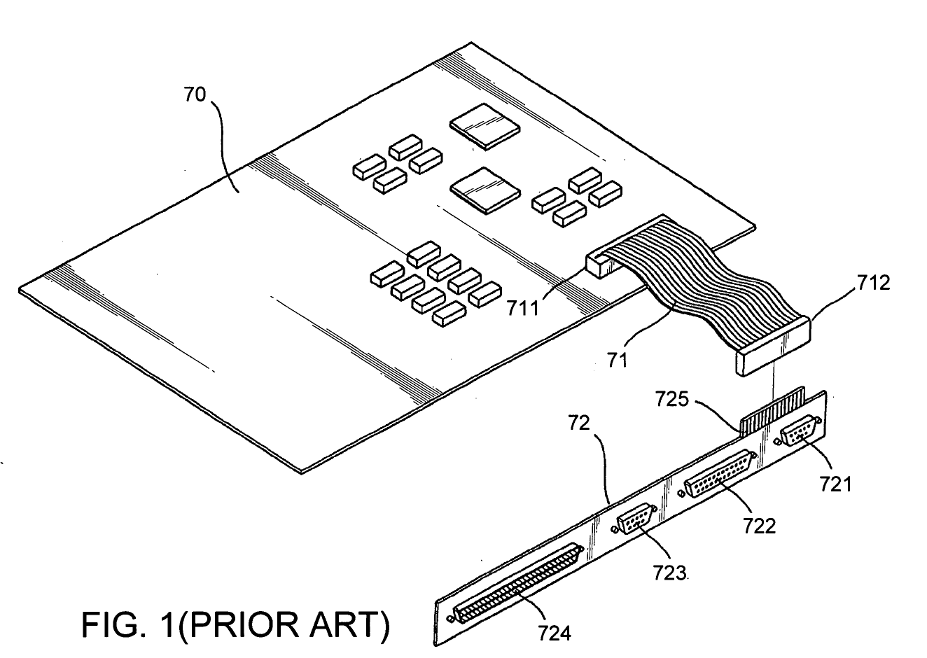

FIG. 2 is a circuit block diagram according to an embodiment of the present invention;

FIG. 3 is a circuit block diagram according to an embodiment of the present invention;

FIG. 4 is a schematic view of an implemented sample according to an embodiment of the present invention; and

FIG. 5 is a partial enlarged view of a certain position C on the motherboard shown in FIG. 4.

### DETAILED DESCRIPTION OF THE INVENTION

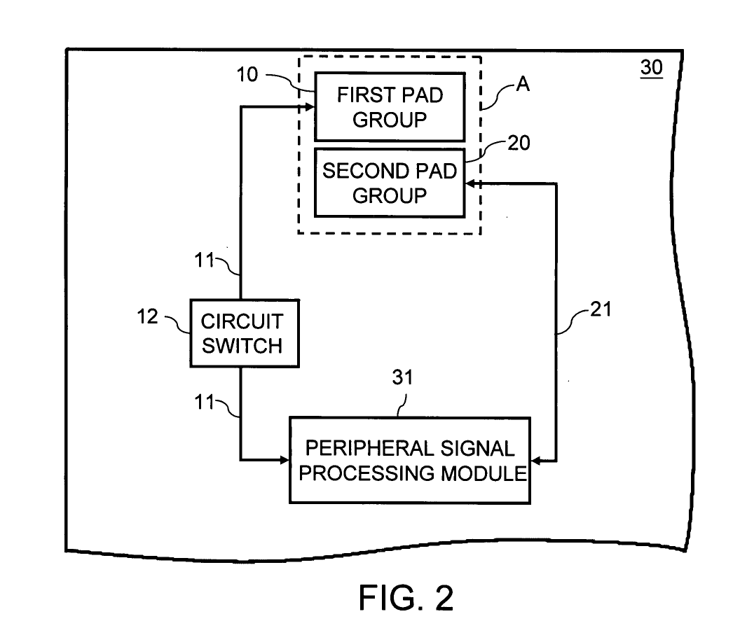

Referring to FIG. 2, a schematic circuit block diagram according to the first embodiment of the present invention is shown. A first contact group 10, a first trace set 11, a circuit switch 12, a second pad group 20, a second trace set 21 and a peripheral signal processor 31 are carried on a motherboard 30.

The first contact group 10, consisting of a group of “electrical contacts” (also referred to pins or pads), is located in a certain position A on the motherboard 30 for coupling with corresponding electrical contacts (pins/pads) of a first signal connecting port (not shown). The first signal connecting port operably connects a first peripheral device (not shown) with the motherboard 30, which in practice is an input/output (I/O) connecting port such as a high speed Ethernet port, an audio port, a universal serial bus (USB), a universal synchronous/asynchronous receiver transmitter (UART), or other interfaces apparent readily to those of ordinary skill in the art.

The first trace set 11, a set of electrical traces, electrically connects the electrical contacts of the first contact group 10, circuit switch 12 and peripheral signal processor 31 sequentially to transmit a first signal (such as audio signal) between the first contact group 10 and peripheral signal processor 31. The first trace set 11 is made of copper wires constructed in the same way as normal printed circuit boards.

The circuit switch 12 switches the first trace set 11 between a connection mode and a disconnection mode, and has a least one signal connecting elements (not shown) as another transmission interface of the first signal to connect to said first peripheral device. In practice, the circuit switch 12 may comprise a pin header and a least one jumper, wherein a plurality of pins (electrical contacts) located on the pin header may be used as an interface of the first signal connecting to the first peripheral device by a signal cable.

The second contact group 20 are also a set of electrical contacts located in position A for coupling with a plurality of corresponding electrical contacts (pins/pads) of a second signal connecting port (not shown). The second signal connecting port operably connects a second peripheral device (not shown) with the motherboard 30, which in practice is an I/O connecting port such as a high speed Ethernet port, an audio port, a universal serial bus (USB), a universal synchronous/asynchronous receiver transmitter (UART), or other interfaces apparent readily to those of ordinary skill in the art.

It should be emphasized that the spatial size of position A in the present embodiment allows to selectively mount only one of the first signal connecting port and the second signal connecting port, but not both within position A.

The second trace set 21, also a set of electrical traces, electrically connects the electrical contacts of the second contact groups 20 and the peripheral signal processor 31 to transmit a second signal between the second contact group 20 and the peripheral signal processor 31. The first trace set 11 may be made of copper wires constructed in the same way as normal printed circuit boards.

The peripheral signal processor 31 is connected with the first trace set 11 and the second trace set 21 respectively for processing the first and second signals from the first signal connecting port and the second signal connecting port. In practice, the peripheral signal processor 31 is a south bridge chip, or a single chip integrated with the functions of south bridge and north bridge chips, which processes and/or deals with signal communication between a Central Processing Unit (CPU) and the peripheral device, possibly capable of covering the signal processing of a PCI bus, a USB, a LAN, an ATA, an SATA, an audio controller, an keyboard controller, an real-time clock controller, an advanced power management, and so on.

With the circuit architecture of the present embodiment, a designer may flexibly select the following options for the motherboard 30 in accordance with actual requirements: (1) configuring said first signal connecting port; (2) configuring said second signal connecting port, and switching the first trace set to the disconnection mode by the circuit switch 12; (3) configuring the second signal connecting port, and using the signal connecting element of the circuit switch 12 as the transmission interface of the first signal.

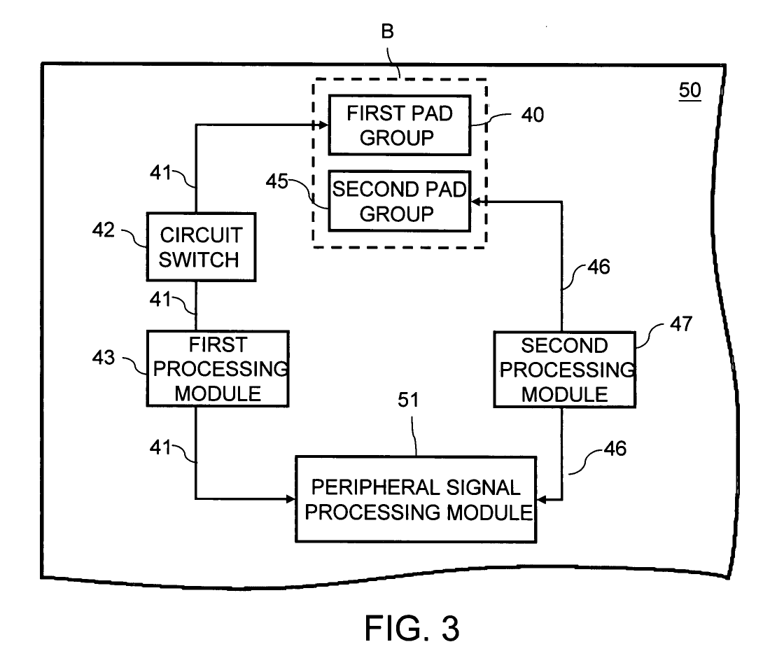

Referring to the circuit block diagram according to an embodiment of the present invention shown in FIG. 3, a motherboard 50 comprises: a first contact group 40 and a second contact group 45 located at the same certain position B on the motherboard 50, a first trace set 41, a circuit switch 42, a first signal processor 43, a second trace set 46, a second signal processor 47 and a peripheral signal processor 51.

The difference between the present embodiment and the former embodiment in accordance with the present invention is that, the present embodiment adds the first signal processor 43 on the first trace set 41 (between the circuit switch 42 and the peripheral signal processor 51) and the second signal processor 47 on the second trace set 46 (between the second pad group 45 and the peripheral signal processor 51). For example, if the first and second signals are the audio signal and the Ethernet signal respectively, the first signal processor 43 and the second signal processor 47 will be an audio chip and an Ethernet chip respectively, and the signal processing performance will be significantly improved.

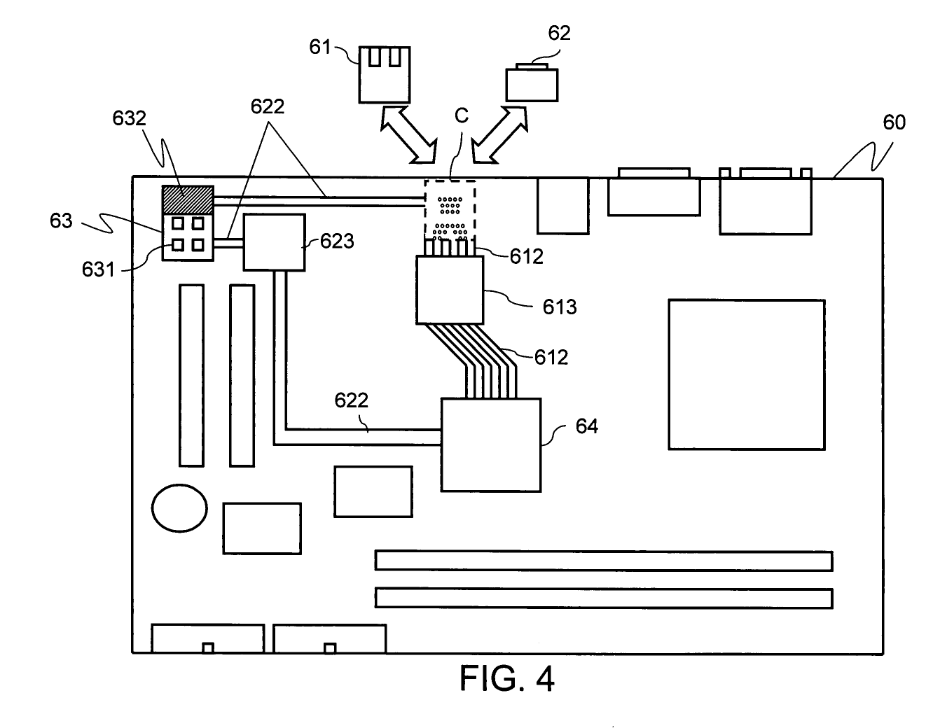

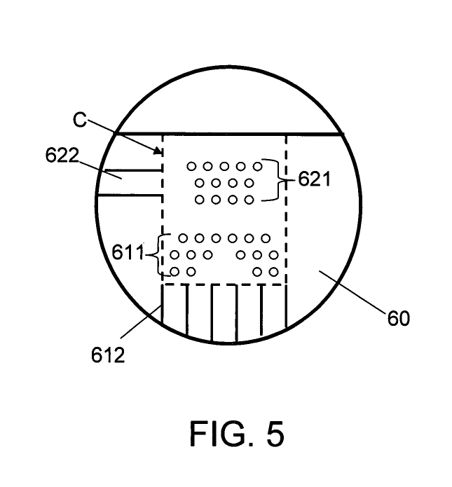

Refer to a schematic view of an implemented sample according to an embodiment of the present invention shown in FIG. 4. Subsequent FIG. 5 shows a partial enlarged view of a certain position C on a motherboard 60 shown in FIG. 4. For illustrative convenience, only main circuit elements on the motherboard 60 are shown with most layout details omitted.

In the present embodiment, a high speed Ethernet port 61 and an audio port 62 are replaceable at the same “physical position” C on the motherboard 60 of an computer system, wherein the circuit architecture covers the following three statuses: (1) only using the high speed Ethernet port 61; (2) only using the audio port 62; (3) using the high speed Ethernet port 61, and also providing audio transmission function via other means.

To meet the requirement for the above three statuses, in the circuit architecture of the motherboard 60, an Ethernet pad group 611 and an audio pad group 621 are configured within the same certain position C (FIG. 4 and FIG. 5), but located in different physical sections thereof.

The high speed Ethernet port 61 has plural pins (not shown) applicable to electrically connect with Ethernet pad group 611 (FIG. 5), thereby sequentially in circuit connection with a second trace set 612, a network signal processing chip 613 and a south bridge chip 64.

The audio pad group 621 (FIG. 5) may be used to connect with the pins of the audio port 62 (not shown), and in circuit connection with an audio processing chip 623 and the south bridge chip 64 via a first trace set 622.

A pin header 63 is configured on the first trace set 622 between the audio pad group 621 and the audio processing chip 623, with a plurality of pins 631 on the top side as signal connecting elements and an extra transmission interface of a first signal (audio signal). and The pin header 63 also has an jumper 632 used as a circuit switch for switching the first trace set 622 between a connection mode and a disconnection mode by positioning the jumper 632 to connect with different pairs (groups) of the pins 631. The switching control of the first trace set 622 may also be achieved by other conventional circuit switching elements.

Directed to the different requirements disclosed above, the circuit is adjusted as follows:

(1) When only the network function is used, the high speed Ethernet port 61 is mounted onto the position C and connected to the Ethernet pad group 611 by its pins; although the audio function is not used, for the purpose of safety, the jumper 632 on the pin header 63 is in the disconnection mode.

(2) When only the audio transmission function is used, the audio port 62 are configured onto the position C with its pins connected to the audio pad group 621, and the jumper 632 on the pin header 63 is in the connection mode.

(3) When both network and audio transmission functions are available, the high speed Ethernet port 61 is configured onto the position C and electrically connected to the Ethernet pad group 611 by its pins, and the jumper 632 on the pin header 63 is in the disconnection mode; meanwhile a predetermined pin(s) of the pins 631 is connected to an built-in loudspeaker of the computer system by an audio cable (not shown) to provide audio output signals.

Through the replaceable input/output interfaces disclosed in above embodiments, the present invention provides a circuit architecture in which pads of different connecting ports are set within a certain position and a circuit switch is used as an extra transmission interface, specification of the connecting port as required can be changed flexibly and the peripheral devices with different functions can be connected depending on the requirements, so as to make a more efficient arrangement on the circuit board with limited area, and to reduce the cost of design and management.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A circuit board for selectively configuring a first signal connecting port or a second signal connecting port at a certain position on the circuit board, comprising:
a peripheral signal processor for processing a first signal and a second signal;
a plurality of first electrical contacts configured within the certain position for electrically connecting the first signal connecting port, the first electrical contacts being in circuit connection with the peripheral signal processor to transmit the first signal;
a plurality of second electrical contacts also configured within the certain position for electrically connecting the second signal connecting port, the second electrical contacts being in circuit connection with the peripheral signal processor to transmit the second signal; and
a circuit switch for circuit connection/disconnection, configured in circuit connection between the first electrical contacts and the peripheral signal processor.

2. The circuit board according to claim 1, wherein the circuit switch has at least one signal connecting element as an extra transmission interface of the first signal.

3. The circuit board according to claim 2, wherein the circuit switch comprises a pin header and at least one jumper, and the signal connecting elements are a plurality of pins located on the pin header.

4. The circuit board according to claim 1, further comprising a first signal processor for processing the first signal, which is configured in circuit connection between the peripheral signal processor and the circuit switch.

5. The circuit board according to claim 1, further comprising a second signal processor for processing the second signal, which is configured in circuit connection between the peripheral signal processor and the second electrical contacts.

6. The circuit board according to claim 1, wherein the first signal connecting port is an audio port.

7. The circuit board according to claim 1, wherein the second signal connecting port is an Ethernet port.

8. The circuit board according to claim 1, wherein the peripheral signal processor is a south bridge chip or a single chip integrated with the functions of a south bridge chip and a north bridge chip.

9. A circuit board for selectively configuring a first signal connecting port or a second signal connecting port at a certain position on the circuit board, comprising:
a peripheral signal processor for processing a first signal and a second signal;
a plurality of first electrical contacts configured within the certain position for connecting the first signal connecting port to transmit the first signal;
a plurality of second electrical contacts also configured within the certain position for connecting the second signal connecting port to transmit the second signal;
a first trace set for electrically connecting the first electrical contacts with the peripheral signal processor to transmit the first signal;
a second trace set for electrically connecting the second electrical contacts with the peripheral signal processor to transmit the second signal; and
a circuit switch for switching the first trace set between a connection mode and a disconnection mode, configured on the first trace set between the first electrical contacts and the peripheral signal processor.

10. The circuit board according to claim 9, wherein the circuit switch has at least one signal connecting element as an extra transmission interface of the first signal.

11. The circuit board according to claim 10, wherein the circuit switch comprises a pin header and at least one jumper, and the signal connecting elements are a plurality of pins located on the pin header.

12. The circuit board according to claim 9, further comprising a first signal processor for processing the first signal, which is configured on the first trace set between the peripheral signal processor and the circuit switch.

13. The circuit board according to claim 9, further comprising a second signal processor for processing the second signal, which is configured on the second trace set between the peripheral signal processor and the second electrical contacts.

14. The circuit board according to claim 9, wherein the first signal connecting port is an audio port.

15. The circuit board according to claim 9, wherein the second signal connecting port is an Ethernet port.

16. The circuit board according to claim 9, wherein the peripheral signal processor is a south bridge chip or a single chip integrated with the functions of a south bridge chip and a north bridge chip.

17. A circuit board for selectively configuring a first signal connecting port or a second signal connecting port at a certain position on the circuit board, comprising:
a first signal processor for processing a first signal;
a second signal processor for processing a second signal;
a plurality of first electrical contacts configured within the certain position for connecting the first signal connecting port to transmit the first signal;
a plurality of second electrical contacts also configured within the certain position for connecting the second signal connecting port to transmit the second signal;
a first trace set for electrically connecting the first electrical contacts with the first signal processor to transmit the first signal;
a second trace set for electrically connecting the second electrical contacts and the second signal processor to transmit the second signal; and
a circuit switch for switching the first trace set between a connection mode and a disconnection mode, configured on the first trace set between the first electrical contacts and the first signal processor, wherein the circuit switch has at least one signal connecting element as an extra transmission interface of the first signal.

18. The circuit board according to claim 17, wherein the circuit switch comprises a pin header and at least one jumper.

19. The circuit board according to claim 18, wherein the signal connecting elements are a plurality of pins located on the pin header.

20. The circuit board according to claim 17, wherein the first signal connecting port is an audio port and the second signal connecting port is an Ethernet port.
